(19) United States
(12) Patent Application Publication
(10) Pub. No.: US 2004/0012626 A1
(43) Pub. Date: Jan. 22, 2004

(54) Method for creating configurable and customizable web user interfaces

(76) Inventor: Timothy J. Brookins, West Fargo, ND (US)

Correspondence Address: Christopher R. Christenson, WESTMAN CHAMPLIN & KELLY, International Centre - Suite 1600, 900 South Second Avenue, Minneapolis, MN, 55402-3319, US

(21) Appl. No.: 10/201,653

(22) Filed: Jul. 22, 2002

(51) Int. Cl. G09G 5/00

(52) U.S. Cl. 345/738

(57) ABSTRACT

A web user interface is defined to include at least one publisher web-part which is adapted to provide publisher information. A service component is configured to receive the publisher information and provide the publisher information to one or more subscribers web-part based upon corresponding subscribers.

### BACKGROUND OF THE INVENTION

The present invention is related to user interfaces. More specifically, the present invention is related to user interfaces presented upon a user's browser computer that are configurable and customizable.

Current web user interfaces, while able to provide virtually any type of information to a user over the web or any other suitable connection, are relatively static, and are not customizable. As used herein, web user interface means any user interface that is executable upon a client browser, and particularly interfaces that employ Hypertext Markup Language (HTML). In cases where configurability is provided, such configurability is still generally within the bounds of that provided by the author of the interface.

Recently, a piece of software technology has been introduced that facilitates and enhances user interface creation. The software is available from Microsoft Corporation of Redmond, Wash., under the trade designation Digital Dashboard. Digital dashboards provide users with a single interface through which they can view information from a variety of sources that have been chosen specifically for that user. In addition, dashboards allow a user to view the information off-line, thereby adding portability. Essentially, a digital dashboard is similar to a nerve center that allows a user to view information consolidated from various sources. These dashboards are customized to allow users to access personal files, e-mail, company databases, web sites and more, all in a single location. A digital dashboard typically provides the user with more than a typical web portal. Specifically, while web portals also supply users with large amounts of information from various sources, the user generally has to figure out how to put this information together in a manner that is useful. A dashboard, on the other hand, is a personalized portal that provides consolidated information to an individual user. Since dashboards are currently based on Microsoft® 2000 technology, they provide analytical and collaborative tools to help knowledge workers use information to make decisions. Additionally, the information supplied by a dashboard can be made available off-line as well as on-line. Digital dashboards typically include a number of web-parts. As used herein, a web-part is any sub-part of a browser page that receives information from an information source. For further information regarding dashboards, see http://www.microsoft.com/business/dd.

While digital dashboards represent a significant advance in a field of user interfaces that execute upon a client browser, there is room to improve the customizability and configurability of the dashboards.

### SUMMARY OF THE INVENTION

A web user interface is defined to include at least one publisher web-part which is adapted to provide publisher information. A service component is configured to receive the publisher information and provide the publisher information to one or more subscriber web-parts based upon corresponding subscriptions generated by the subscriber web-part(s).

### BRIEF DESCRIPTION OF THE DRAWINGS

FIG. 1 is a diagrammatic view of a computing system environment on which embodiments of the present invention may be implemented.

FIG. 2 is a diagrammatic view of a web user interface with which embodiments of the present invention are particularly useful.

FIG. 3 is a more detailed diagrammatic view of a web user interface in accordance with embodiments of the present invention.

FIG. 4 is a diagrammatic view of communication between publisher web parts and subscriber web parts in accordance with embodiments of the present invention.

### DETAILED DESCRIPTION OF ILLUSTRATIVE EMBODIMENTS

Embodiments of the present invention generally provide a protocol for using a service component provided in a known software framework in combination with a plurality of web-parts in such a way to allow communication between the web-parts.

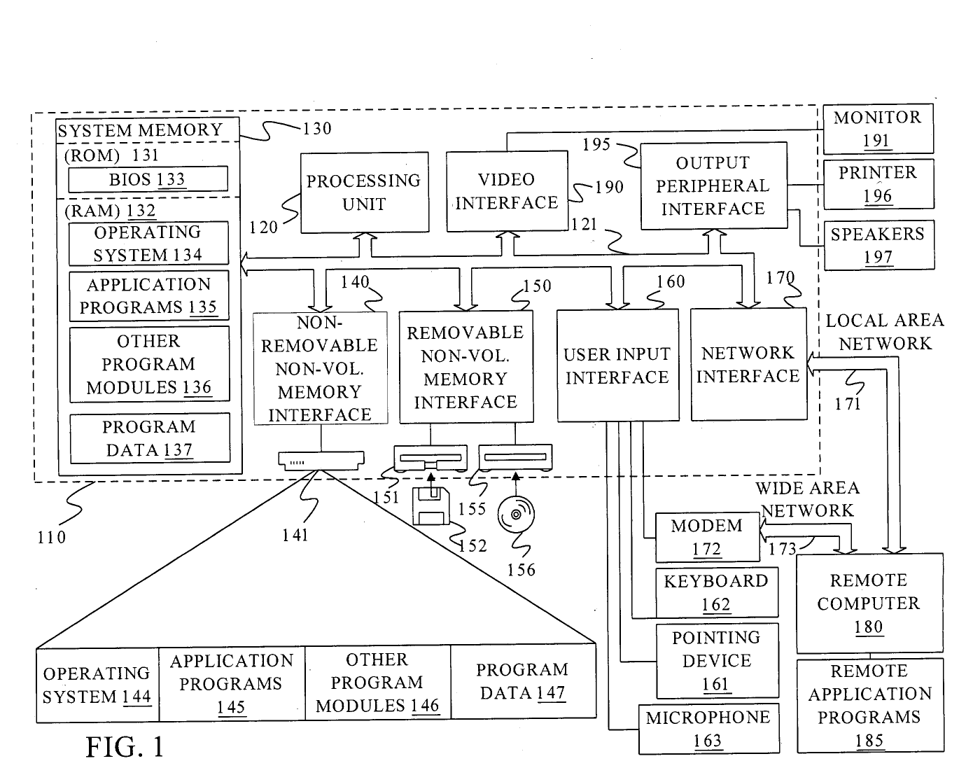

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during startup, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

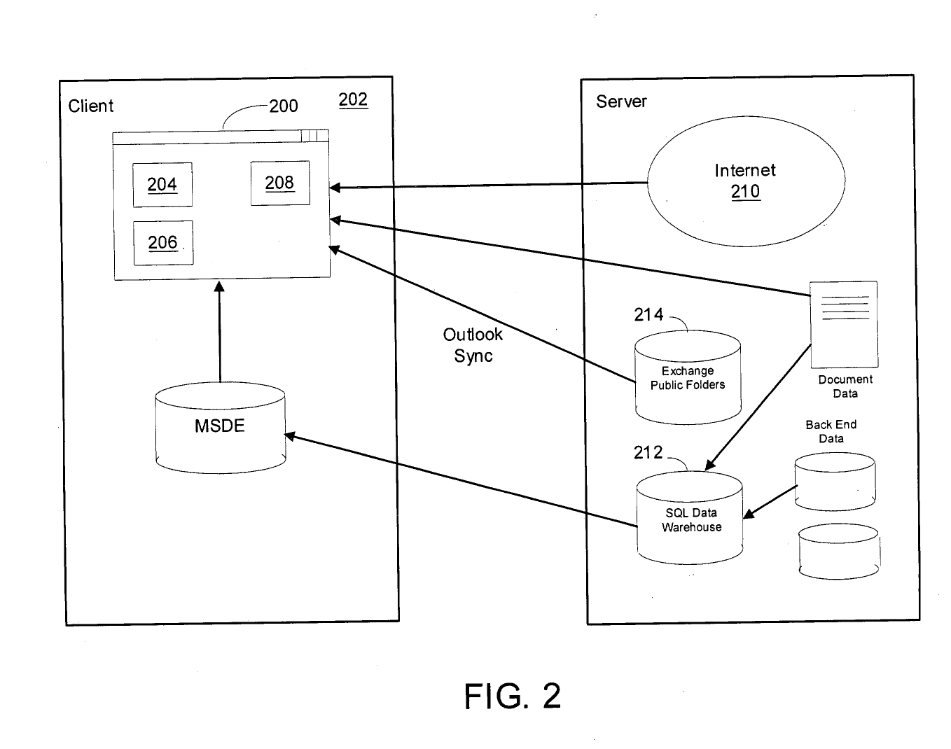

FIG. 2 illustrates a web user interface 200 deployed upon client 202 which interface 200 includes a number of web-parts 204, 206 and 208. As illustrated in FIG. 2, interface 200 is shown drawing data from a number of data sources 210, 212 and 214 and displaying information to the user. Data sources illustrated include the internet, Microsoft Exchange, relational data in an SQL server table. However, any type of information that can be presented in the form of a browser page may be provided in a web-part. One type of core web-part can be considered simply a URL (Uniform Resource Locator). The web-part can typically be maximized and minimized thereby allowing a relatively large number of such web-parts to be presented upon interface 200 and arranged such that only web-parts of interest are maximized and viewed at a given time.

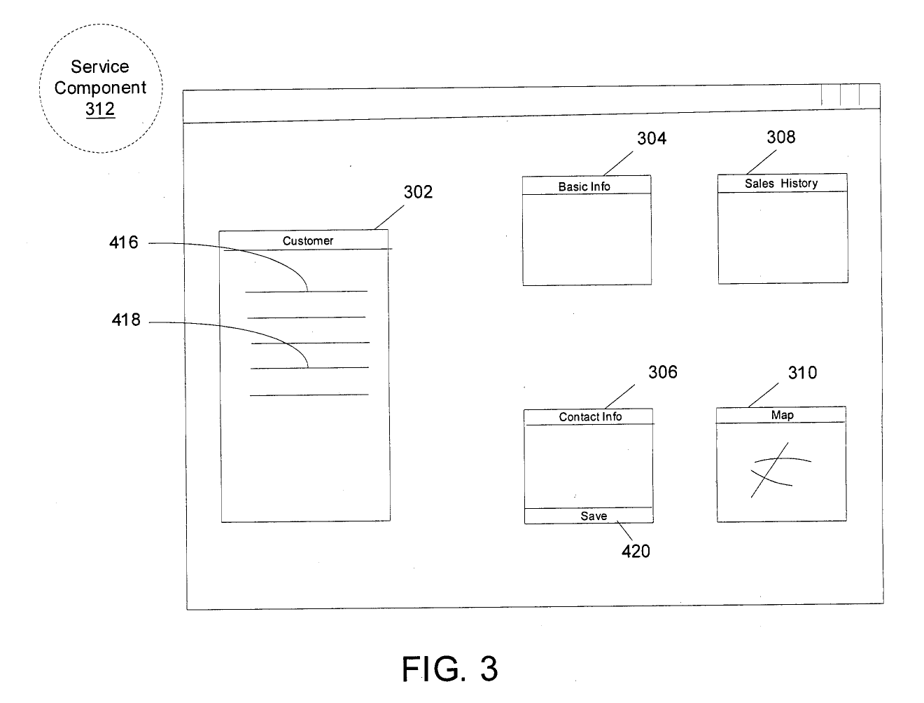

FIG. 3 is an example of a web user interface 300 where various web-parts 302, 304, 306, 308 and 310 contain inter-related information. Since user interface 300 is a user interface provided upon a browser (such as a web user interface) it typically has not provided a mechanism for allowing sub-components therein to communicate with one another and/or be aware of one another. This is in distinct contrast to typical Win 32 user interfaces which are generally highly coupled together providing rich interaction and communication, but unable to be as configurable as web-parts under Digital Dashboard.

While web user interfaces, and specifically those using Digital Dashboard, do not generally provide communication and/or interawareness among the web-parts, Digital Dashboard does provide a type of a event broker known as the Digital Dashboard service component. As will be set forth in greater detail below, embodiments of the invention generally feature a method of employing an event broker, such as service component 312, to facilitate inter-web-part information exchange as well as other suitable activities. Any web-parts 302, 304, 306, 308 and 310 can communicate with service component 312 and request that when a given event occurs with respect to a given entity, that the web-part be notified of such. Further, any of web-parts 302, 304, 306, 308 and 310 can be publishers thereby providing information relative to an event that the web-part receives to service component 312. Thus, service component 312 can be considered a type of event broker that sits between an information source and an information receiver. Information sources can include web-parts, the client browser, or any other suitable source of information. This broker allows two web parts that have no direct knowledge of each other to successfully communicate.

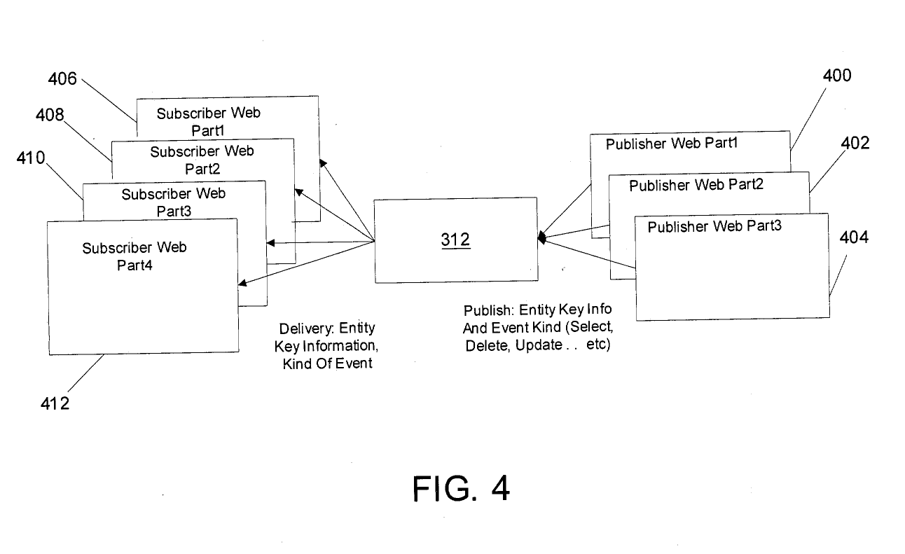

FIG. 4 is a diagrammatic view of intercommunication between publisher web-parts 400, 402 and 404 with subscriber web-parts 406, 408, 410 and 412 through service component 312. Subscriber web-parts register a subscription with service component 312. Subscriber web-parts can be interested in certain parts or types of information. For example, Contact Information web-part 306 (shown in FIG. 3), can be considered a parameterized query in that it takes a parameter, such as a customer key, performs a query using the parameter, and provides the results in result viewer. When Contact Information web-part 306 makes its subscription to service component 312, that subscription will indicate that it will receive Select events related to its parameter, Customer. Thus, in a general sense, a web-part will subscribe to entity information and indicate the kind of event in which it is interested.

Referring back to FIG. 3, user interface 300 includes Customer web-part 302, Basic Information web-part 304, Contact Information web-part 306, Sales History web-part 308 and Map web-part 310. Users of web user interface 300 can access an administrative utility provided by the software and change the configuration of user interface 300 to rearrange web-part locations, change the parameterized query that defines the web-part, or other suitable features.

The interconnectedness between web-parts, in accordance with embodiments of the present invention, is provided as illustrated in the following example. When a user clicks on a customer, such as that indicated at 416 in FIG. 3, user interface 300 will refresh populating the related web-part fields, 304, 306, 308 and 310 with the related information for the customer selected at 416. This is done by setting up a configuration whereby the Customer web-part 302 indicates to service component 312 that it has received an event, such as Select. Web-parts, such as web-part 302 can also publish other types of events that occur. For example, such events may include, without limitation, Select, AddNew, Delete, Update, or any other suitable type of event. Thus, when a user clicks on the customer indicated at 416, web-part 302 indicates that the entity key corresponding to the customer clicked at 416 has been Selected. Service component 312 receives this event and provides a notification of such to any subscriber web-parts that have subscribed, with an indication of interest in receiving the selected entity key information and event type. Thus, any web-parts that have subscribed to Customer keys and Select events, will be notified of the Select event for the Customer key corresponding to customer 416. Then, each subscriber web-part acts upon the event in accordance with the content that they provide in their own web-part. For example, web-parts 304, 306 and 308 are simply queries. Web-parts 304, 306 and 308 formulate and submit appropriate queries to their individual data sources and display the resultant data therein.

One of the manners in which embodiments of the present invention provide configurability and customization to end users is by allowing users to create new queries and define the way in which the results of the user-defined query is displayed, such as a user-defined “skin”, or appearance. Thus, a user can define his or her own web-part as desired. For example, if there is a portion of information stored in a remote database, the user can simply create a web-part for that portion of information by creating a query to obtain that information using any suitable query creation tools, and create any particularized output formatting to present the results of the user-defined query.

Web-part 310 differs from web-parts 304, 306 and 308 in that web-part 310 displays a map. Web-part 310, using methods described above, receives information indicative of a subscribed to event, such as address information relative to a customer selected in web-part 302 and creates a URL from that information and provides the URL to a known map server, such as MSN map server and in response receive a graphical image to be displayed therein.

Referring back to FIG. 4, a series of subscribers 406, 408, 410 and 412 are illustrated. Additionally, a series of publishers 400, 402 and 404 are also illustrated. When the page loads upon the client browser, each subscriber contacts service component 312 and registers a subscription. There are several pieces of information that are provided with each subscription. Specifically, one type of information is the fully qualified name of the entity that the subscriber web-part wants to read. A second type of information is the kind of event in which the subscriber web-part is interested. A third type of information that can be provided to service component 312 is whether the subscriber web-part wants the opportunity to cancel a change of some sort. For example, suppose a user begins to change information in the Contact Information web-part 306 (shown in FIG. 3) and clicks on a different customer, such as indicated at 418 before selecting save button 420. If this situation is not carefully dealt with, it is possible for a user to lose data that was entered into the Contact Information web-part because interface 300 will move to new customer information corresponding to customer 418 in response to the errant click. In this case, if web-part 306 has subscribed to service component 312 using an indication that it wants the option to cancel the events, then this situation can be dealt with properly.

When an event occurs, a publisher web-part can inquire whether it is allowed to publish. This allows interface 300 to provide for the opportunity for subscriber web-parts to cancel the publication. If no web-parts are interested in potentially canceling publication, the publishing web-part simply publishes the event. However, in the example given above, when a user erroneously clicks on customer 418, web-part 302 inquires whether it is allowed to publish new information. Service component 312 then asks each subscriber that has indicated an interest in cancellation whether it is okay to publish the given event. If all such subscribers reply yes, then the event is published. However, if a web-part, such as web-part 306 has information that has not been saved, web-part 306 can inquire of the user whether that information should be saved before the new event published. In this manner, the effects of erroneous interaction with user interface 300 can be reduced or eliminated altogether.

In summary, web-part coordination and communication is provided in accordance with embodiments of the present invention. This facilitates configurability and customization of user interfaces on a client browser using a relatively fundamental abstraction within a currently available software framework. Although the present invention has been described with reference to particular embodiments, workers skilled in the art will recognize that changes may be made in form and detail without departing from the spirit and scope of the invention.

What is claimed is:

1. A user interface executable on a client browser, on a client computer, the user interface comprising:
a publisher web-part adapted to provide publication event information in response to an event received by the publisher web-part;
a subscriber web-part adapted to generate a subscription indicative of subscription information of interest to the subscriber web-part; and
a service component receiving the subscription from the subscriber web-part and selectively providing the publication event information to the subscriber web-part based upon the subscription.

2. The interface of claim 1 and further comprising at least one additional publisher web-part.

3. The interface of claim 1 and further comprising at least one additional subscriber web-part.

4. The interface of claim 1 wherein the publication event information includes a full entity key.

5. The interface of claim 4 wherein the publication event information includes event type information.

6. The interface of claim 5 wherein the event type information includes Select.

7. The interface of claim 5 wherein the event type information includes Delete.

8. The interface of claim 5 wherein the event type information includes AddNew.

9. The interface of claim 5 wherein the event type information includes Update.

10. The interface of claim 1 wherein the subscription includes an entity type.

11. The interface of claim 10 wherein the subscription further includes an event type.

12. The interface of claim 11 wherein the event type is Select.

13. The interface of claim 11 wherein the event type is Delete.

14. The interface of claim 11 wherein the event type is AddNew.

15. The interface of claim 11 wherein the event type is Update.

16. The interface of claim 10 wherein the subscription further includes an indication of whether the subscriber web-part will cancel publication in selected circumstances.

17. The interface of claim 16 wherein the subscriber web-part generates a user dialog in the selected circumstances.

18. The interface of claim 17 wherein a selected circumstance includes the subscriber web-part having un-saved information when the publication event information is provided to the service component.

19. A method of refreshing a web-user interface, the method includes steps of:
receiving an event in a publication web-part;
providing information indicative of the event to a service component; and
selectively providing the information indicative of the event to at least one subscriber web-part based upon a subscription registered with the service component by the at least one subscriber web-part.
